(19) United States
(12) Patent Application Publication
(10) Pub. No.: US 2015/0213203 A1
(43) Pub. Date: Jul. 30, 2015

(54) SYSTEM AND METHOD OF EXPEDITING LEGAL ACCESS OF EMERGENCY MEDICAL RECORD OF PATIENT UTILIZING TWO DIMENTINAL INFORMATION-EMBEDDING SCANNABLE CODE AND PROPRIETARY SCANNER APPLICATION THEREFOR

(71) Applicant: Anthony Brian Cumbie, Rosebud, TX (US)

(72) Inventor: Anthony Brian Cumbie, Rosebud, TX (US)

(21) Appl. No.: 14/162,738

(22) Filed: Jan. 24, 2014

(51) Int. Cl. G06F 19/00

(52) U.S. Cl. CPC G06F 19/323

(57) ABSTRACT

A system and method of enabling expedited legal access of EMR record of a patient is provided. The system comprises means for receiving EMR data of a patient. The system further comprises propriety application means for retrieving EMR data of a patient. The proprietary application means comprises scanning means and data-retrieving means. The scanning means is configured to scan QR-code of the patient. The EMR-data-retrieving means is configured to retrieve full EMR data of the patient from a non-http-addressed server whose address is derived from http-address encoded in the scanned QR-code. The system further comprises means for verifying credential of a medical emergency professional (MEP) so as to enable the MEP to use the propriety application means.

### CROSS-REFERENCE TO RELATED APPLICATION

This application claims the benefit under 35 U.S.C. §119(e) of Provisional Patent Application No. 61/755,967, filed Jan. 23, 2013, the entire disclosure of which is hereby incorporated by reference.

### BACKGROUND

1. Technical Field

The present disclosure generally relates to a system and method of expediting legal access of the emergency medical record (EMR) of a patient, and more particularly relates to system and method of expediting legal access to the EMR of a patient utilizing two dimensional information-embedding scannable code (such as QR code) and proprietary scanner application therefor.

2. Description of the Related Art

With the advancement of technologies, two dimensional information-embedding scannable code, such as QR code, has been increasingly used in various fields, especially with the availability of image-capturing devices (such as camera), image recognition technologies, and scanner applications (that are used to read information embedded in such two-dimensional code) in smart mobile devices such as smart phones. For the ease of discussion, hereinafter QR code will be used in place of two dimensional information-embedding scannable code, with the understanding that other two dimensional information-embedding scannable code may also be used in, or applicable to, the subject matter under discussion.

Scannable code has been used in accessing the EMR of patient. Conventional EMR providers, if using scannable codes, mostly utilize one dimensional barcode carried by a patient. One dimensional barcode, however, usually only encodes numbers, and thus does not hold many characters within a reasonable length. For example, a standard U.P.C./EAN barcode holds 14 numeric digits. For medical emergency professionals, this limitation can result in high cost or inconvenience retrieving the EMR of a patient using a conventional EMR provider.

More specifically, a one-dimensional barcode carried by a patient typically only encodes numeric identification information about a patient specific to an EMR provider. As a result, in one scenario, a medical emergency professional trying to get access of the patient's EMR is forced to use an expensive closed system provided by a particular EMR provider. In another scenario, if an EMR provider uses an open system, the medical emergency professional must in advance possess, or spend effort to acquire, information about the open system of EMR provider (such as a URL of the EMR provider's open system), and then take manual steps to access the EMR provider's open system in order to get the patient's EMR, after retrieving the numeric identification information of the patient by scanning the barcode carried by the patient. Thus, for medical emergency professionals, retrieving the EMR of patient using a conventional EMR provider utilizing one-dimensional barcode carried by a patient can result in high cost or inconvenience.

Additionally, medical emergency professionals, such as paramedics, nurses and doctors, are required to be in compliance with federal or state legislations such as HIPAA and HITECH, in order to legally retrieve a patient's EMR. For example, a medical emergency professional is required to respond to, acknowledge the receipt of, or sign, HIPAA/HITECH compliance notices when accessing an EMR provider's open system and proceeding to retrieve the EMR of a patient. For medical emergency professionals, this results in inconvenience and delay in retrieving the EMR of a patient.

Accordingly, there is a need for a system and method that allows medical emergency professionals to conveniently and inexpensively access EMR of patients while in compliance with applicable federal or state legislations, such as HIPAA and HITECH.

### BRIEF SUMMARY

In the first aspect, the present disclosure provides a novel and inventive bracelet carrying a QR code embedding information identifying a patient as well as information about an EMR provider having an open system, such that scanning of the QR code can conveniently lead to access of the EMR of the patient. The bracelet is structured and configured to be an ornamental bracelet that covers the QR code when accessing of the EMR of the patient is not in need. The bracelet is structured and configured to fully uncover the QR code for scanning purpose when there is a need to access the EMR of the patient.

In the second aspect, the present disclosure provides a system and method of registering medical emergency professionals for the downloading and use of a proprietary scanner application, such that only approved and authenticated medical emergency professionals can download and use proprietary scanner application for the purpose of retrieving the EMR of a patient. With the registration process, steps otherwise required for a medical emergency professional to respond to, or acknowledge receipt of, HIPAA/HITECH compliance notices are legally eliminated when using the proprietary scanner application, thus expediting the medical emergency professional's legal access of the EMR of a patient.

In the third aspect, the present disclosure provides a system and method of registering a patient for collecting the patient's EMR and providing the patient with a QR code (uniquely linked to the patient) that an approved and authenticated medical emergency professional can scan to retrieve the EMR of the patient during an emergency situation. In one embodiment, a patient may purchase a bracelet containing an unused QR code and subsequently register with a backend system using the QR code. In another embodiment, a patient may first register with the backend system, and will later be provided with a QR code after the registration process is completed.

In the fourth aspect, the present disclosure provides a system and method of conveniently retrieving the EMR of a patent utilizing a QR code carried by the patient and a proprietary scanning application tailored to expedite legal access of the EMR of the patient. In order to use the proprietary scanner application, a medical emergency professional must be pre-approved and authenticated (verified). In one embodiment, the proprietary scanner application, upon recognizing patient identification information from an HTTP URL contained in the received QR code, derives a corresponding URL of a non-HTTP protocol and sends a request for getting the EMR of the patient corresponding to the patient identification information using the derived URL. After receiving the request for the EMR of the patient, the server module mapped to the derived URL retrieves and sends to the proprietary scanner application for display the requested EMR of the patient. On the other hand, if a generic scanner application is used to scan the QR code, the server module mapped to the HTTP URL returns a web page containing only basic medical record of the patient.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein.

FIGS. 1A-F are perspective views illustrating a first exemplary QR-code-carrying bracelet, according to one or more embodiments of the present disclosure.

FIGS. 2A-F are perspective views illustrating a second exemplary QR-code-carrying bracelet, according to one or more embodiments of the present disclosure.

FIG. 3 is a functional block diagram illustrating a disclosed system 300 of expediting legal access of EMRs of patients utilizing QR codes carried by patients, according to one or more embodiments of the present disclosure.

FIG. 4 is a diagram illustrating component data stores of an exemplary master data store provided on a backend system of a disclosed system 300, in accordance with one or more embodiments of the present disclosure.

FIG. 5 is a functional block diagram illustrating an exemplary client device 304, in accordance with one or more embodiments of the present disclosure.

FIGS. 6A-B are flowcharts illustrating a patient registration process as a part of the disclosed system 300 of expediting legal access of the EMR of a patient, according to two or more embodiments of the present disclosure.

FIG. 7 is a flowchart illustrating a medical emergency professional registration process as a part of the disclosed system 300 of expediting legal access of the EMR of a patient, according to one or more embodiments of the present disclosure.

FIG. 8 is a flowchart illustrating how a client-side proprietary application gets legal access of the EMR of a patient carrying a QR code in an expedient and secure manner, in accordance with one or more embodiments of the present disclosure.

FIG. 9 is a flowchart illustrating how a web service module on the backend of the disclosed system 300 responds to a request for providing the EMR of a patient sent by a client-side proprietary application, in accordance with one or more embodiments of the present disclosure.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof. Also, descriptions of well-known functions and constructions are omitted for clarity and conciseness.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. Moreover, the use of the terms first, second, etc. do not denote any order or importance, but rather the terms first, second, etc. are used to distinguish one element from another.

Within the descriptions of the different views of the figures, the use of the same reference numerals and/or symbols in different drawings indicates identical, similar, or close related items, and similar or closely related elements can be provided similar names, reference numerals, and reference alpha-numerals throughout the figures. If a reference numeral is once used to refer to a plurality of like elements, unless required otherwise by context, the reference numeral may refer to any, a subset of, or all of, the like elements in the figures bearing that reference numeral. Thus, for example, if reference numeral “132” is once referred to a fastening means or device or any element of the fastening means or device, reference numeral “132” may then also refer to any, a subset of, or all of, the elements of the fastening means or device, or the fastening means or device in its entirety, and reference alpha-numeral “132A” may then refer to one implementation or one portion of the fastening means or device, or any, a subset of, or all of the elements of that implementation or that portion. The specific identifiers/names, reference numerals and reference alpha-numerals assigned to the elements are provided solely to aid in the description and are not meant to imply any limitations (structural or functional or otherwise) on the described embodiments.

In the description, relative terms such as “back,” “front,” “left,” “right,” “vertical,” “horizontal,” “upper,” “lower,” “top” and “bottom” as well as any derivatives thereof (e.g., “left side,” “upper rail,” etc.) should be construed to refer to the logical orientation as then described or as shown in the drawing figure under discussion. These relative terms are for convenience of description and are not intended to convey any limitation with regard to a particular orientation.

In the present disclosure, the terms “module”, “sub-module”, “application”, “application module”, “software”, “software program”, “software module”, “programmatic module”, “code”, “application code”, “programmatic code”, “object”, “programmatic object”, “script”, “routine”, “service routine”, “function”, “service”, “engine”, “processor”, “component”, and so on, when context allows or requires, may be used interchangeably to refer to one or more sets of computer instructions adapted to perform, when executed by a processor (such as a microprocessor or a microcontroller), one or more specific functions.

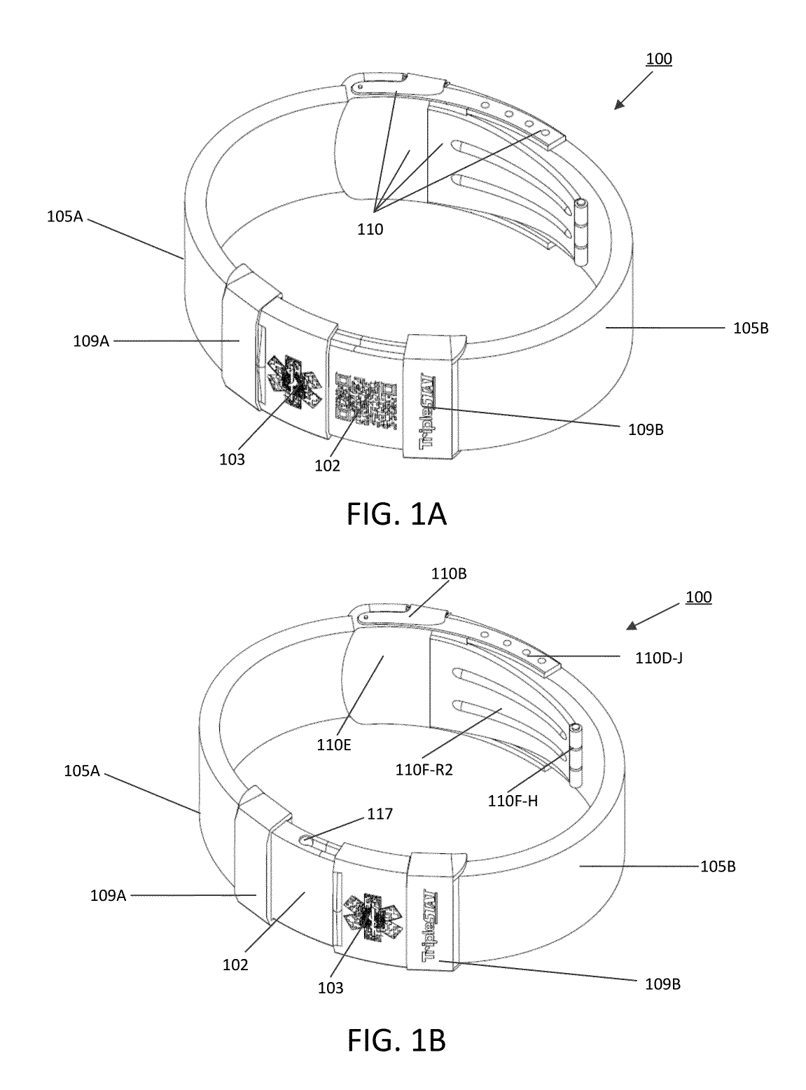

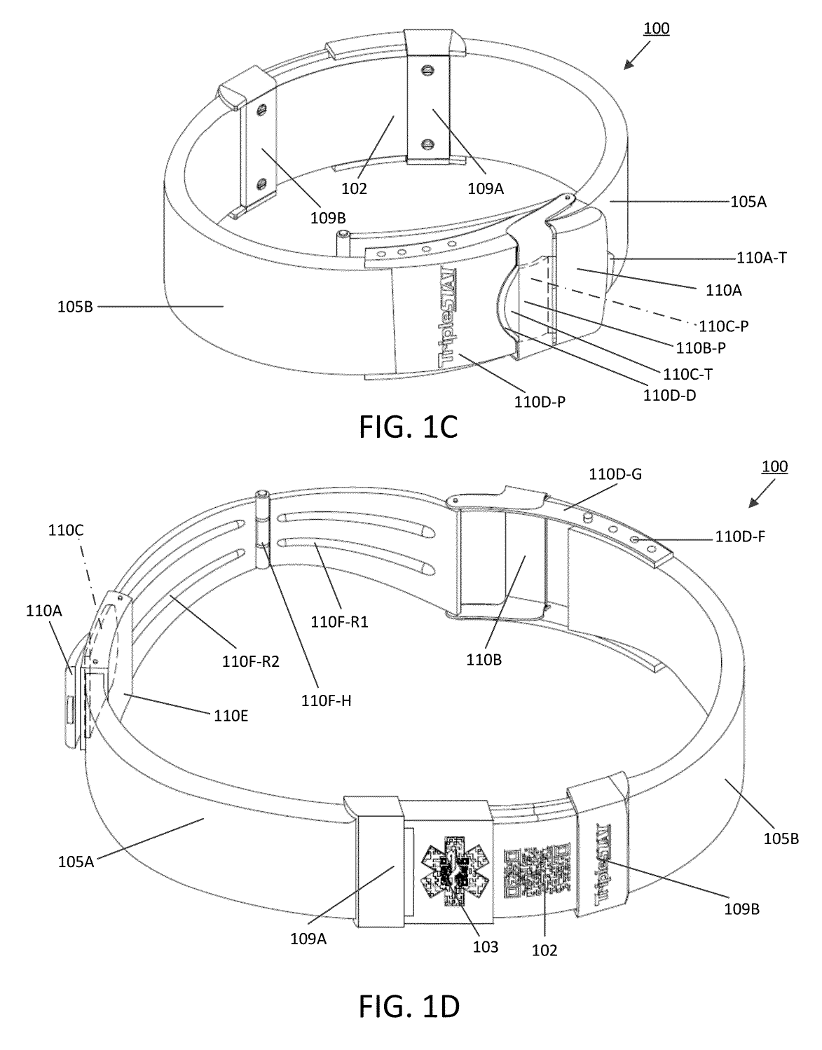

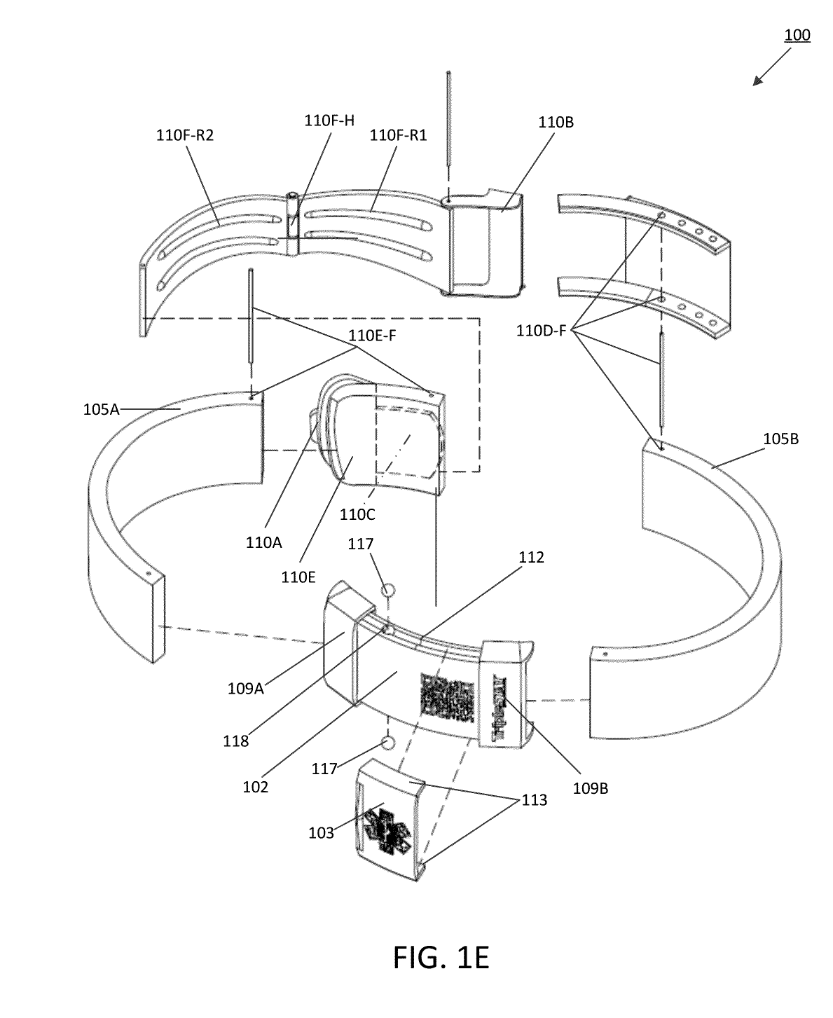

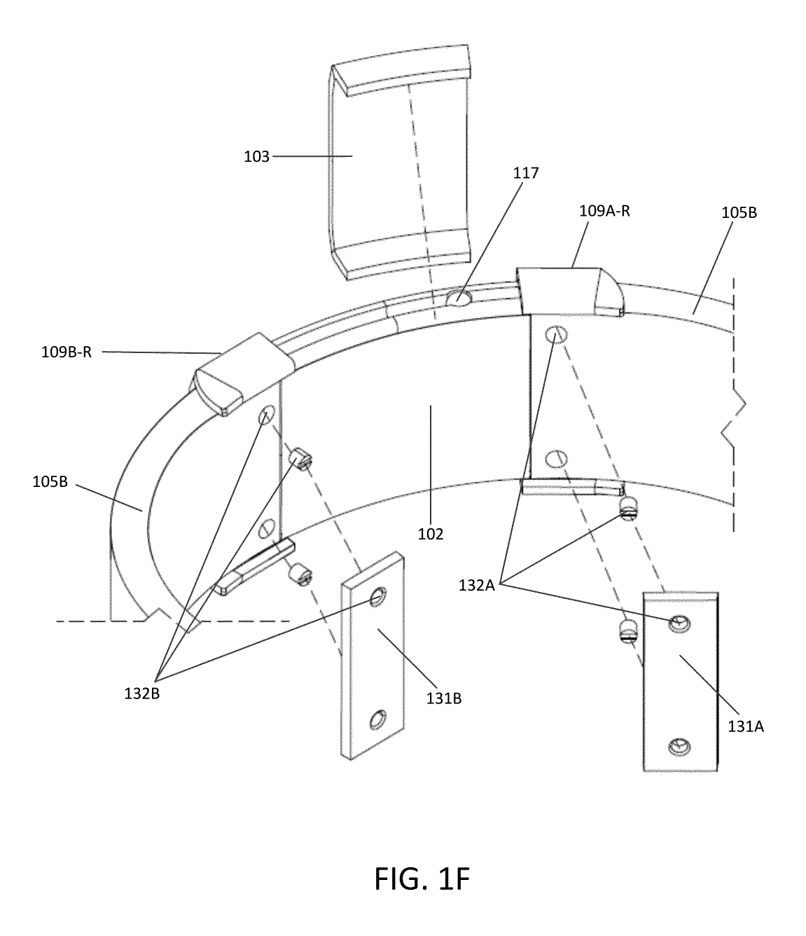

With reference now to the figures, and beginning with FIGS. 1A-F, there are different views illustrating an exemplary QR-code-carrying bracelet 100, according to one or more embodiments of the present disclosure. Specifically, FIGS. 1A-B are two perspective front views illustrating two configurations of the exemplary bracelet 100 in which the QR code is revealed and covered, respectively. FIG. 1C is a perspective back view illustrating the exemplary bracelet 100. FIG. 1D is a perspective front view illustrating the exemplary bracelet where the clasp member 110 of the exemplary bracelet 100 is in a released (unlocking or unwinding) configuration. FIG. 1E is an exploded perspective view illustrating components of the exemplary bracelet 100. FIG. 1F is an exploded sectional view illustrating components of one or more sections of the exemplary bracelet 100.

Referring to FIGS. 1A-F, bracelet 100 comprises a QR-code bearing member (QRCBM) 102, door member 103, linking members 109A and 109B, band members 105A and 105B, and clasp member 110.

QRCBM 102 is structured and configured to bear or otherwise carry a QR-code and provide infrastructure for enabling uncovering and covering of the carried QR-code. In one implementation, QRCBM 102 is a base plate 102 with the front thereof bearing a QR-code. Base plate 102 is of such a shape and dimension that a QR code of a customary size can be fully formed thereon. Base plate 102 may be made of one or several layers. In one implementation, as shown, the top and bottom sides 112 are so structured and configured as forming a pair of slidable tracks 112. One or more pairs of hemispherical depressions 118 are formed on top and bottom sides 112, respectively. A corresponding pair of elastic locking balls 117 are seated or otherwise partially received in a corresponding pair of depressions 118, respectively. Each locking ball is so configured that when the locking ball is seated in a corresponding depression 118, the locking ball can be pressed down when there is a force applied thereon and can resume its original shape when there is no force applied thereon. In one implementation, each locking ball is spring-biased. Additionally or alternatively, each locking ball may be made of a flexible material.

Base plate 102 may be made of any or a combination of materials, such as plastic, platinum, alloy, metal, steel, ceramic, silicone, rubber, and leather. Base plate 102 may be made of one layer. Alternately, base plate 102 may be made of several layers bonded, compressed, or otherwise joined together to form an integral plate of a suitable dimension, with one layer bearing the carried QR-code. The carried QR code may be indelibly printed on the front surface of base plate 102 using known printing technologies. Additionally or alternately, the carried QR code may be etched, engraved, or carved into the front surface of base plate 102 using laser or other known technologies.

Door member 103 is configured to uncover and cover the carried QR-code through actuatable engagement with QRCBM 102. As shown, in one implementation, door member 103 is u-channel bracket 103 of such configurations and dimensions that enable its top and bottom horizontal side parts 113 to be in sliding engagement with the pair of top and bottom slidable tracks 112 of base plate 102. Optionally, the respective undersides of its top and bottom side parts 113 each may have one or more depressions (not shown) corresponding to the one or more depression 118s on either the top or bottom sliding track 112 for receiving part of one or more corresponding locking balls 117 not received in the one or more corresponding depressions 118.

In this implementation, bracket 103 may be snapped onto the pair of top and bottom sliding tracks 112 so as to have its front surface of its vertical main frame (bearing a Life Star sign) in front of the front surface of base plate 102 with its two side parts 113 in sliding engagement with top and bottom sliding tracks 112. Under a non-emergency situation where there is no need to show the carried QR-code, bracket 103 may be slid along tracks 112 with its side parts 113 to a covering position such that the carried QR-code is fully covered by the front surface of bracket 103. With this QR-code-covered configuration, the exemplary bracelet 100 can be used for the ornamental purpose when worn, e.g., on the wrist.

Under an emergency situation where the carried QR-code needs to be scanned by a medical emergency professional (MEP) for retrieving EMR of the patient wearing the bracelet, bracket 103 may be slid (by, e.g., the MEP) along tracks 112 with its side parts 113 to an uncovering position such that the carried QR-code is fully uncovered as a result of the sliding away of the front surface of bracket 103. In one implementation, as bracket 103 is moving towards the uncovering position, the respective underside surfaces of its pair of side parts 113 meet, and exert force onto, the pair of locking balls 117 (seated in corresponding depressions 118) slightly protruded from the pair of top and bottom tracks 112, respectively. This results in increasing tensions between the underside surfaces of side parts 113 and surfaces of protruded locking balls 117, respectively, which makes the sliding along tracks 112 increasingly difficult. As bracket 103 moves to the uncovering position, the tensions between the underside surfaces of side parts 113 and surfaces of protruded locking balls 117 effectively lock bracket 103 from further sliding, thereby stabilizing bracket 103 so as to facilitate the exposing of and scanning of the uncovered QR-code.

In the implementation where the underside surfaces of side parts 113 each have one or more pairs of depressions corresponding to the one or more pairs of depressions 118 on the pair of top and bottom tracks 118, when bracket 113 moves to the uncovering position, the one or more pair of depressions on the underside surfaces of side parts 113 are aligned with the one or more pairs of depression 118, a configuration which may facilitate the locking of bracket 103, with the respective protruded parts of the one or more locking balls 117 fully or partially received in the corresponding depressions of the underside surfaces of side parts 113.

Thus, bracket 103 may be actuated to slide between a covering position and an uncovering position to cover and uncover the carried QR-code, respectively. Customarily, the front face of the main vertical frame of bracket 113 bears a custom Star of Life so as to alert an MEP that QR code can be uncovered by sliding bracket 103 away from the covering position.

Linking members 109A and 109B are structured and configured to link QRCBM 102 to band members 105A and 105B. Linking members 109A and 109B may also be configured to serve as stoppers at both lateral ends of QRCBM 102 to stop or otherwise prevent door member 103 from further sliding. As shown, each linking member 109 may include a receptacle structure 109-R (such as 109A-R or 109B-R) that is fastened to or otherwise tightly coupled to one lateral end of QRCBM 102 in such a manner that a receptacle is formed for receiving one end of a band member at the lateral end of QRCBM 102. In one implementation, QRCBM 102 and receptacle structure 109-R may collectively form one integral structure.

As shown, each linking member 109 may further include a fastening block 131 and a plurality of fastening means 132 that are collectively used to fasten one end of a corresponding band member 105 to the receptacle structure 109-R as the end of band member 105 is received in the receptacle formed by the fastening of the receptacle structure 109-R to the corresponding lateral end of QRCBM 102. In one implementation, a fasten block 131 has a pair of fastening holes 132. For each fastening hole, a fastening screw 132, a fastening bolt 132, or one other known fastening device 132 is used to fasten the end of the band member 105 received in the receptacle between fastening block 131 and the receptacle structure 109-R. Thus, with linking members 109A and 109B, band members 105A and 105B are each securely linked to, or otherwise tightly coupled to, one lateral end of QRCBM 102.

Band members 105A and 105B may be made of known materials used to make band members of a conventional bracelet. As shown, in one implementation, each of band members 105A and 105B is of similar, or otherwise comparable, height to that of QRCBM 102. As shown, one end (proximal end) of each band member is tightly coupled to one lateral end of QRCBM 102, while the respective distal ends of both band members 105 are fastened to, or otherwise coupled to, each other through clasp member 110, thereby forming a close looped bracelet 100.

Clasp member 110 is structured and configured to couple one loose end of one band member 105 to one loose end of the other band member 105 in either a locking configuration or an unlocking configuration. The locking configuration of clasp member 110 renders the closed loop of the bracelet having a smaller diameter suitable for letting a user securely wear the resulting bracelet on the wrist without worrying that the resulting bracelet is too loose on the user's wearing wrist. The unlocking configuration of clasp member 110 renders the closed loop of the bracelet having a bigger diameter suitable for letting a user to take the resulting bracelet off the user's wrist.

In one implementation, as shown, clasp member 106 comprises locking part 110A, connector part 110B, wedging part 110C, anchoring part 110D, fastening part 110E, and hinged folding part 110F.

Locking part 110A is a plate-like structure having a locking tab 110A-T, which is configured to facilitate lifting-up entire locking part 110A. Locking part 110A is coupled to wedging part 110C such that the lifting-up of locking part 110A pulls the wedging part 110C away from anchoring part 110D and the pressing-down of locking part 110A pushes the wedging part 110C towards anchoring part 110D. Wedging part 110C includes wedging plate 110C-P and semi-circular wedging tab 110C-T. In one implementation, wedging tab 110C-T is spring-biased and is slightly raised above wedging plate 110C-P when no downward force is exerted thereon.

Anchoring part 110D is a plate-like structure having anchoring plate 110D-P and a pair of top and bottom perpendicularly turned flanges 110D-G. Anchoring plate 110D-P has a semi-circular dent (depression) 110D-D on the left edge. Depression 110D-D substantially matches the shape and size of wedging tab 110C-T. The pair of flanges 110D-G have a series of pairs of adjustment fastening holes 110D-F each for adjustably fastening the loose distal end of band member 105B to the pair of flanges 110D-G using fastening pin 110D-F at one end (the distal end) of clasp member 110. Thus, other configurations or conditions being equal, using the outermost pair of fastening holes 110D-F to fasten one loose end of a band member renders the resulting closed loop of bracelet 100 having the biggest diameter while using the innermost pair of fastening holes 110D-F renders the closed loop of bracelet 100 having the smallest diameter. Thus, the diameter of the closed loop of bracelet 100 can be adjusted by selecting a different pair of fastening holes 110D-F.

Fastening part 110E is fastening structure having a receptacle to receive (through the proximal end thereof) and fasten a loose distal end of band member 105A to fastening part 110E through fastening means 110E-F (shown in FIG. E) at the proximal end of clasp member 110. As shown, locking part 110A is pivotably coupled to fastening part 110E behind the received distal end of band member 105A. Hinged folding part 110F comprises hinge 110E-H and two hinged arms 110E-R1 and 110E-R2 hingedly coupled to each other through hinge 110E-H. The unhinged end of hinged arm 110E-R2 is fastened to or otherwise coupled to the distal end of fastening part 110E.

Connector part 110B is structured and configured to couple fastening part 110E at the proximal end of clasp member 110 and anchoring part 110D at the distal end of clasp member 110. In one implementation, as shown (e.g. in FIG. 1D), connector part 110B implements the coupling by coupling itself to both unhinged end of hinged arm 110E-R1 and the pair of top and bottom flanges 110D-G of anchoring 110D.

As shown, to form a locking configuration of clasp member 110, the whole structure of clasp member 110 is collapsed by folding hinged arm 110E-R2 against and over hinged arm 110E-R1 (via hinge 110E-H) towards and against anchoring part 110D. Wedging part 110C is then forced to go immediately under the connector plate 110B-P of connector part 110B, which is situated or otherwise disposed in between locking part 110A and anchoring plate 110D-P of anchoring part 110D. That is, wedging part 110C wedges between plate 110B-P in the back and plane formed by back surface of fastening part 110E and back surface of hinged arm 110E-R1 as a result of the collapsing. At first, locking part 110A is in an unlocking (lifted-up) position. To fully lock clasp member 110, locking part 110A is pressed down, which forces (urges) wedging part 110C to move towards anchoring plate 110D-P. The locking part 110A and wedging part 110C are so structured and configured that when the locking part 110A is fully pressed down, wedging tab 110C-T is urged past connector plate 110B-P and reaches depression 110D-D, thus springing back to its raised position. This results in connector plate 110B-P being now tightly sandwiched between raised wedging tab 110C-T and locking part 110A, and becoming unmovable. Accordingly, the whole structure of clasp member 110 becomes fully locked, and the entire bracelet forms a securely locked close loop.

To unlock the already locked clasp member 110, a user can press down wedging tab 110C-T and lifting up locking part 110A (by, e.g., lifting locking tab 110A-T). The lifting-up of locking part 110A in effect pulls wedging part 110C away from anchoring plate 110D. As the wedging tab 110C-T is pressed down to a position substantially in flush with the rest of wedging part 110C, the pulling forces wedging tab 110C-T to go under connector plate 110B-P with the rest of wedging part 110C. This allows connector part 110B to be able to move again, thus allowing hinged arms 110E-R1 and 110E-R2 to unfold away from anchoring part 110D, thereby allowing the entire clasp member to expand so as to reach au unlocking (unwinding) configuration. This configuration, as shown in FIG. 1D, renders the closed loop of bracelet 100 having a diameter comfortably bigger than the diameter when the clasp member is in the locking configuration.

As a skilled artisan appreciates, there can be various changes made to bracelet 100 without departing from the scope and spirit of the present disclosure. As one example, instead of using a sliding configuration, door member 103 may use a folding/unfolding configuration to cover or uncover the QR code formed on QRCBM 101. As another example, band members 105A and 105B can be of different height from that of QRCBM 101. As yet another example, linking members 109A and 109B may use different fastening means to link QRCBM 102 to band members 105A and 105B. As yet another example, a differently structured and configured clasp member 106 may be used to lock, unlock and adjust the diameter of the otherwise formed closed loop of bracelet 100. As yet another example, the structure and configuration illustrated in connection with a bracelet, or similar structures and configurations, may also be used on or applied to jewelry, watches, pendants and etc. such that these items may carry a QR code in one or more manners similar to what have been disclosed above in connection with bracelet 100.

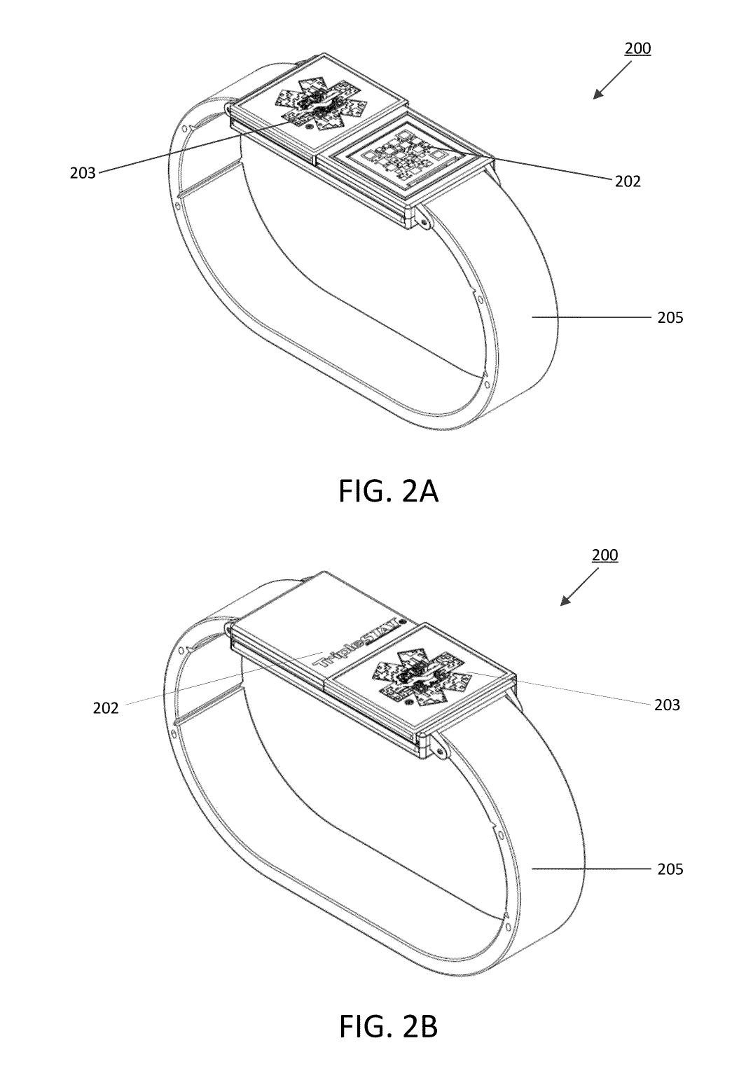

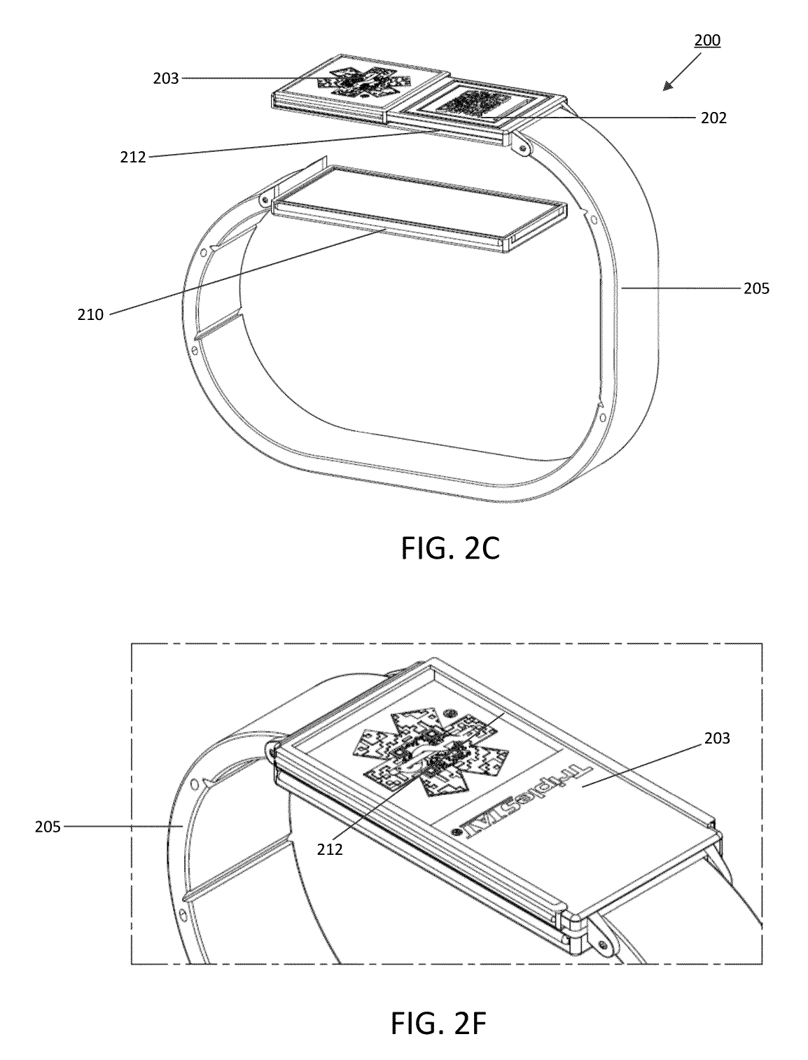

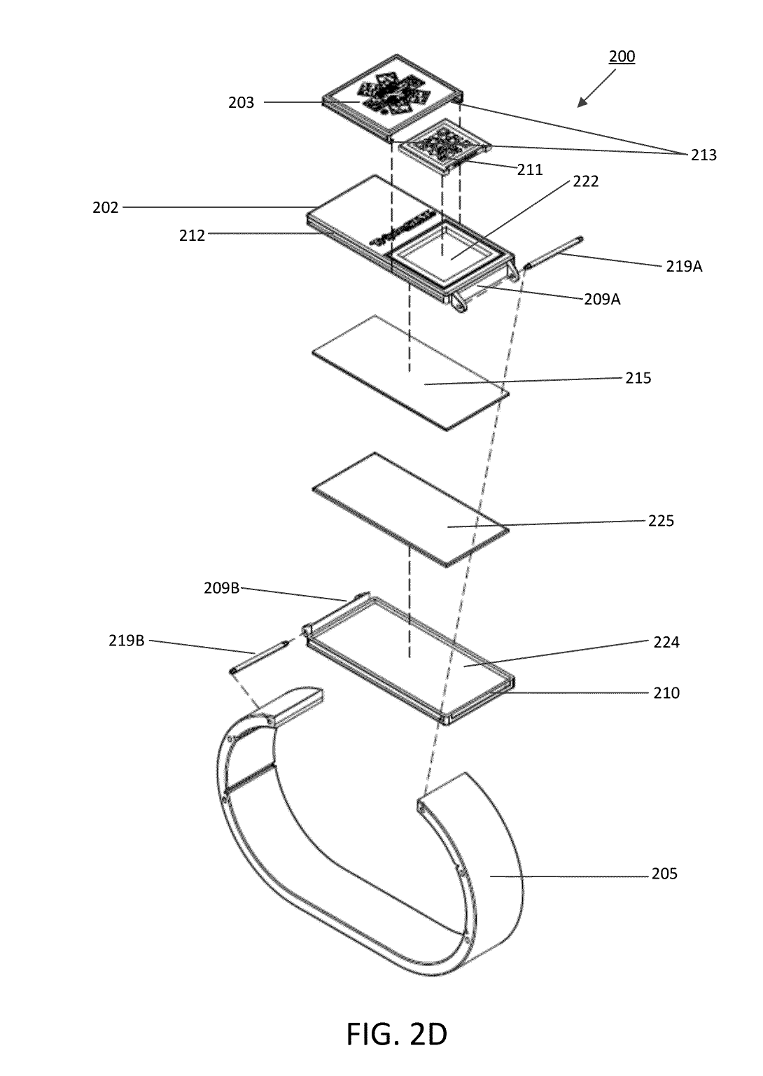

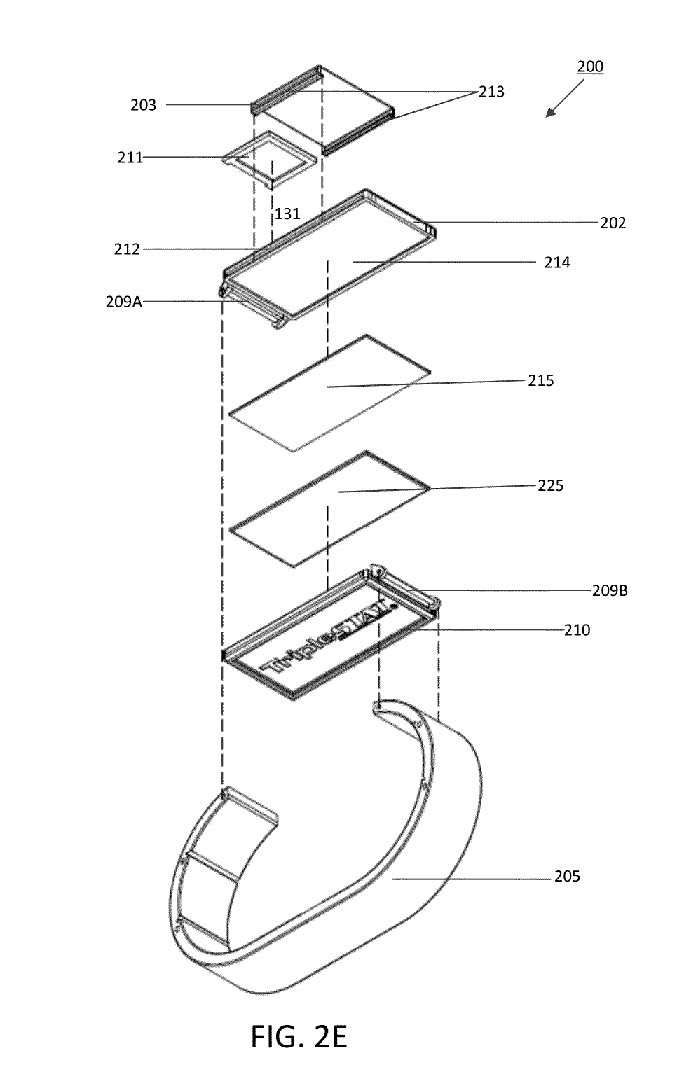

FIGS. 2A-F are different views illustrating another exemplary QR-code-carrying bracelet 200, according to one or more embodiments of the present disclosure. Specifically, FIGS. 2A-B are two perspective views illustrating two configurations of the exemplary bracelet 100 in which the QR code is revealed and covered, respectively. FIG. 2C is a perspective view illustrating a release configuration of exemplary bracelet 200 in which an otherwise closed loop of bracelet 200 is easily opened. FIGS. 2D and 2E are respectively exploded perspective top and bottom views both illustrating components of the exemplary bracelet 200. FIG. 2F is a sectional view illustrating alternative sliding and covering mechanisms used by the exemplary bracelet 200 to cover and uncover the carried QR-code.

Specifically, exemplary bracelet 200 is a variant of bracelet 100 while within the same scope and spirit of the inventive subject matter of bracelet 100. Referring to FIGS. 2A-D, bracelet 200 comprises a QR-code bearing member (QRCBM) 202, door member 203, linking members 209A and 209B, band member 205, and loop-forming member 210.

Similar to QR-code bearing member 102 of bracelet 100, QR-code bearing member 202 is structured and configured for bear or otherwise carry a QR-code and provide infrastructure for enabling uncovering and covering of the carried QR-code. Similar to QRCBM 102, QRCBM 202 is implemented as base plate 202 providing a space configured to bear a QR-code of a customary dimension as well as sliding mechanism enabling door member 203 to slide between a covering position and uncovering position so as to respectively cover and uncover the carried QR-code.

In one implementation, as shown, base plate 202 comprises a recessed chamber 222 of such a dimension that enables a removable QR-code-bearing plate 211 (usually of a similar dimension) to be snuggly and securely disposed therein. Plate 211 contains a magnet. Alternately, plate 211 is by itself a magnet. The carried QR code may be etched out of the magnet and then enameled. With respect to sliding mechanism, there are a pair of length-wise side grooves 212 formed on both length-wise sides of base plate 202, respectively. As shown in FIG. 2E, the underside of base plate 202 contains a recessed chamber 214 configured to house a magnet plate 215. The plate-like magnet 215 may be adhered to the bottom surface of recessed chamber 214 by one or more adhesives such as epoxy. When the respective polarities of magnet 215 and the magnet contained in QR-code-bearing plate 211 are opposite, QR-code-bearing plate 211 is secured to the bottom surface of the recessed chamber 222 through attractive magnet force generated between the two magnets.

In one implementation, base plate 202 may be made of steel. Magnet 215 may have a thickness of 0.5 mm. The magnet contained in QR-code-bearing plate 211 may also have a thickness of 0.5 mm. If QR-code-bearing plate 211 is by itself a magnet, magnet 211 may have a thickness of 1.2 mm.

Similar to door member 103 of bracelet 100, door member 203 is also configured to uncover and cover the carried QR-code through actuatable engagement with QRCBM 202. Similar to u-channel bracket 103 of bracelet 100, door member 203 is u-channel like bracket 203. Bracket 203 has a pair of rims 213 providing slight overhang to the u-channel form by its two sides. Bracket 203 is of such a dimension that it may be snapped onto base plate 202, with the pair of rims 213 snapped into the pair of grooves 212 of base plate 202 and becoming in slide engagement with the pair of grooves 212, respectively. Thus, similar to bracket 103 of bracelet 100, bracket 203, after being snapped onto base plate 202, also can slide along the length of base plate 202 (via its rims 213's sliding engagement with corresponding side grooves 212 of base plate 202) to uncover or cover the carried QR-code.

For bracelet 200, only one band member 105 is used to form a closed loop. In one implementation, band member 105 is implemented in the form of a band made of silicone.

Loop-forming member 210 is configured to form a closed loop of bracelet 200 with QRCBM 202. In one implementation, loop-forming member 210 is also implemented in the form of a base plate 210. Base plate 210 has same or similar horizontal planar dimensions to those of base plate 202. Thus, the horizontal cross section of base plate 210 is same or similar to that of base plate 202. As shown, the top of base plate 210 has a recessed chamber 224 of similar dimensions to the recessed chamber 214 at the bottom of base plate 202. The recessed chamber 224 is configured to house another magnet plate 225. The plate-like magnet 225 may be adhered to the bottom surface of recessed chamber 224 by one or more adhesives such as epoxy. Dimension-wise, magnet 225 is same or similar to that of magnet 215. Thus, in one implementation, magnet 225 also has a thickness of 0.5 mm. The polarity of magnet 225 is the opposite of that of magnet 215. Thus, as shown in FIGS. 2A and 2B, when base plate 202 (having magnet 215) is placed on top of base plate 210 (having magnet 225), the attractive magnetic force generated between now contacting magnets 215 and 225 results in base plate 202 and base plate 210 securely joined to each other to form one integrated assembly.

Linking members 209A and 209B are each affixed to one end of either base plate 202 or base plate 210. Similar to linking members 109A and 109B of bracelet 100, linking members 209A and 209B are each structured and configured to securely couple one end of band member 105 to a base plate structure (namely, either base plate 202 or base plate 210). In one implementation, as shown, each linking member 209 is a u-channel bracket 209, which receives one end of band member 105 in its u-channel and fastens the received end of band member 105 to its two side parts using a fastening pin 219. With linking member 209A linking one end of band member 105 to QR-code-bearing base plate 202 and linking member 209B linking the other end of band member 105 to loop-forming base plate 210, a secure closed loop of bracelet 200 is formed when base plate 202 and base plate 210 are matching placed together. With this magnetic-force-based loop configuration, the closed loop usually cannot be broken with without deliberate human pulling force. Thus, the closed loop bracelet 200 can be comfortably worn on the wrist or worn on the neck as a pendent. When a deliberate human pulling force is applied to both base plates 202 and 210 or one of the two base plates, base plates 202 and 210 can be easily separated from each other, thus allowing the bracelet to be taken off a user's wrist or neck.

A skilled artisan appreciates that various changes can be made to bracelet 202 without departing from the scope and spirit of the inventive subject matter associated with bracelet 202 For example, one or more sliding and cover mechanisms different from the sliding and cover mechanism shown in FIGS. 2A-E may be used to uncover and cover the carried QR-code. FIG. 2F illustrates an alternative sliding and cover scheme that can be used to implement QR-code-bearing base plate 202. Specifically, a recessed area is formed length-wise on the top of base plate 202. A pair of internal grooves 212 are formed by the bottom surface of the recessed area, side walls of the recessed area, as well as rims providing overhang to the recessed area. The Star of Life is formed on the bottom surface of the recessed area (rather than on the front surface of a door member 2003). With this configuration, a door member 203 can be slid along the pair of internal grooves 212 to cover and uncover the carried QR-code.

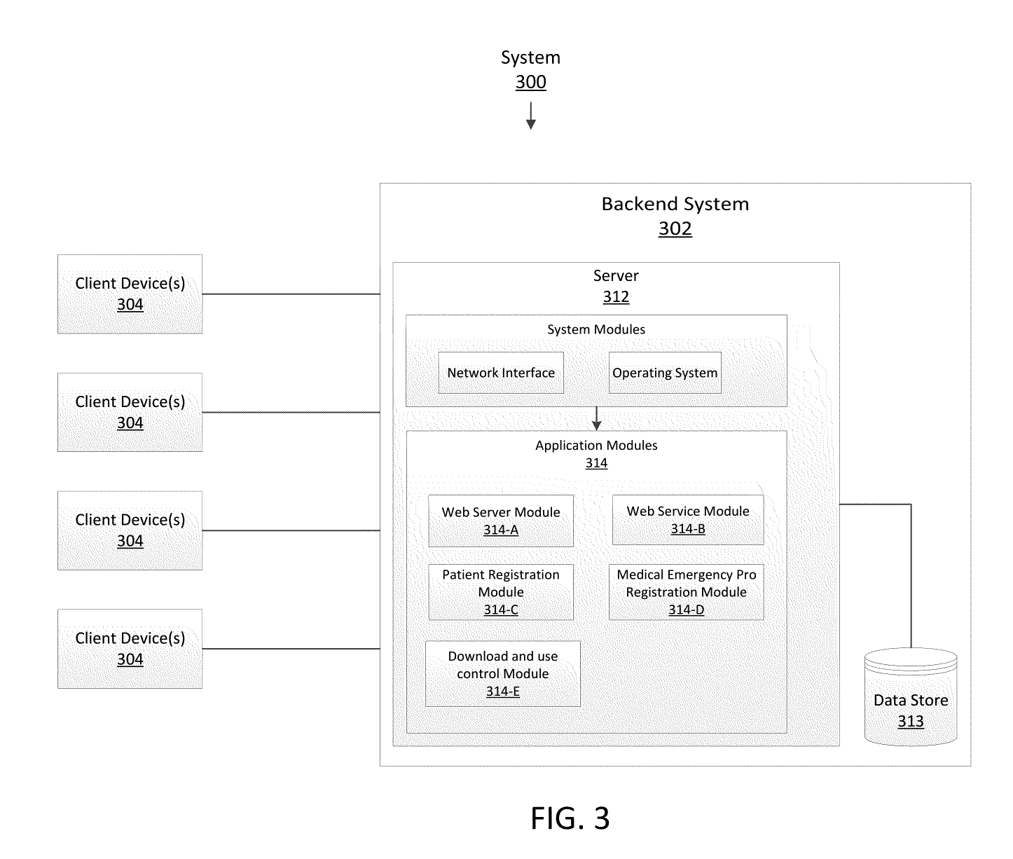

FIG. 3 is a functional block diagram illustrating system 300, which is a system of expediting legal access of EMRs of patients utilizing QR codes carried by patients, according to one or more embodiments of the present disclosure. Referring to FIG. 3, the system comprises client devices 304 and backend system 302, which are connected via one or more communication networks (not shown), such as Internet, one or more cellular networks, and/or one or more local area networks.

Client devices 304, as shown in FIG. 3, can be any computing devices having networking capabilities, such as PDAs, smart phones, PCs, notebook computers and tablet computers. Backend system 302 comprises server 312 and data store 313. Server 312 may be a single computing machine (such as a workstation computer) or a cluster of interconnected computing machines. Server 312 comprises functional modules, including hardware modules, software modules, and/or modules combining software and hardware. These functional modules include system modules (which comprise a network interface and an operating system) and application modules 314. Each application module 314 contains one or more sets of programmatic code, which is programmed and configured to perform one or more sets of specific functions when executed by one or more microprocessors of server 312 (not shown). In this embodiment, application modules 314 include a web server module 314-A, a web service module 314-B, a patient registration module 314-C, a medical emergency professional registration module 314-D and download and use control module 314-E.

Data store 313 may include any known local or distributed retrievable storage means, such as one or more local or distributed databases, one or more local or distributed file systems, one or more system or file caches, one or more system memories, one or more removable storages, or any combination thereof, where data can be stored and retrieved programmatically. Server 312 and data store 313 are communicative coupled to each other. In one embodiment, Data store 313 resides in server 312. In another embodiment, data store 313 resides in one or more different computing machines from server 312.

A client device 304 and backend system 302 (via, e.g., server 312) can be communicated with each other using one or more known communication protocols (such as HTTP, FTP, Web Service), one or more proprietary communication protocols, or any combination thereof, so that data can be exchanged between the client device 304 and backend system 302. In one instance, patient data are uploaded from one client device 304 to server 312, and then stored in data store 313. In another instance, another client device 304 sends a request to server 312 requesting for patient data previously uploaded to backend system 302. Server 312, upon receiving the request, retrieves patient data from data store 313, and lets the requesting client device 304 download the retrieved patient data from server 312 for display.

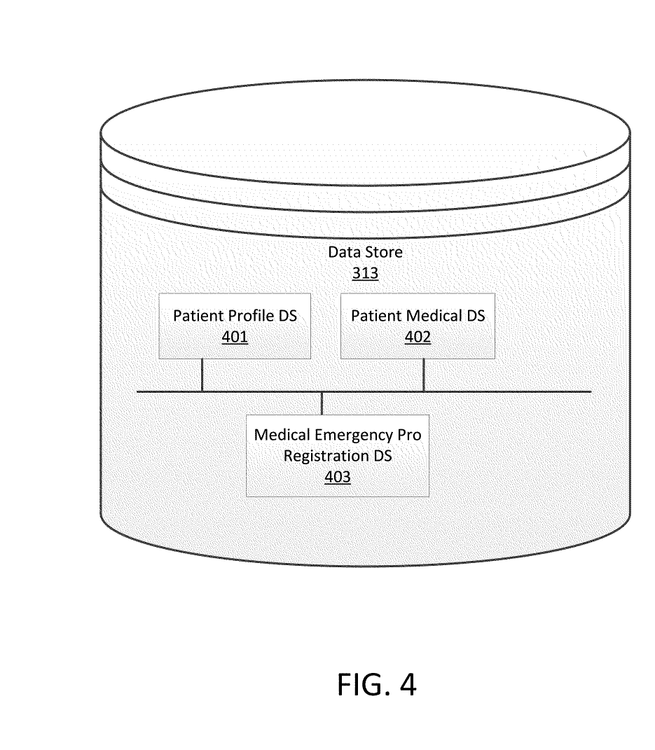

FIG. 4 illustrates an exemplary data store 313, according to one or more embodiments of the present disclosure. In one embodiment, data store 313 comprises three component data stores (DS), namely, patient profile DS 401 (hereinafter referred to as “PPDS 401” or simply as “PPDS”), patient medical DS 402 (hereinafter referred to as “PMDS 402” or simply as “PMDS”), and medical emergency professional registration DS 403 (hereinafter referred to as “MEPRDS 403” or simply as “MEPRDS”).

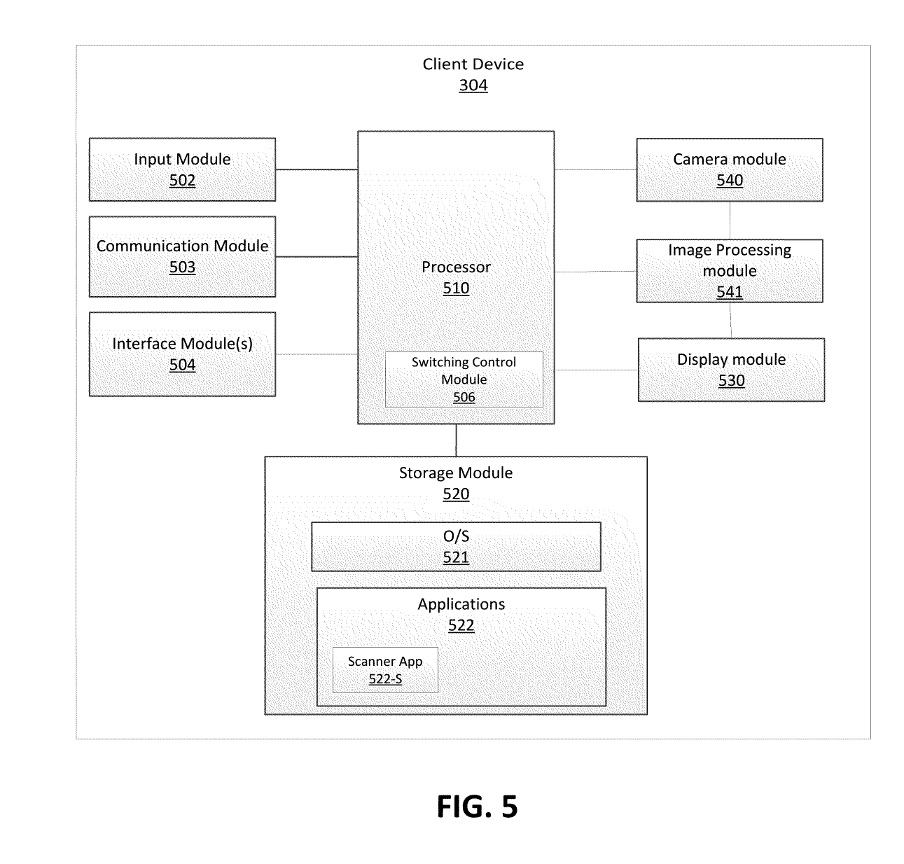

FIG. 5 is a functional block diagram illustrating a client device 304, according to one or more embodiments of the present disclosure. Referring to FIG. 5, a client device 304 comprises processor 510, which may be a microprocessor or a microcontroller. A client device 304 may further comprise communication module 503, an input module 502, a display module 530, a storage module 520, a camera module 540, and one or more interface modules 504, which are all communicatively coupled to processor 510 so as to either provide data to processor 510 or receive data from processor 510.

Communication module 503 exchange data with an external device using wired and/or wireless communication means included therein according to various communication protocols. As one example, if the host client device 304 is a smart phone or tablet PC, communication module 503 may comprise an RF unit as a wireless communication means. As another example, if the host client device 304 is a desktop or laptop PC, communication module 503 may comprise both an Ethernet-based network interface unit as a wired communication means and an antenna unit supporting an 802.11 standard protocol as a wireless communication means.

Display module 530 can be any display device, such as an LCD display screen. Display module 503 may display user input data or output data provided by an application running on the host client device 304. Display module 503 may include a touch screen which allows user to input data. In that case, display module 503 may serve as an input device.

Input module 502 receives input from a user and provides the received input to processor 510 for further processing by software programs running in processor 510. Input module 502 may include input keys, a touch screen, a QWERTY keyboard, a touchpad, or any combination thereof.

Storage module 520 stores applications 522 and operating system 521, which may be loaded into processor 510 for execution. Storage module 520 may also store data used by applications 522 and operating system 521. Storage module 520 may encompass various internal and external storage media, such as RAM, ROM, smart card, flash memory, and any external storage accessible via communication module 503 through one or more communication networks (such as a cellular network or Internet). Applications 522 are software programs or modules commonly referred to as “apps” when the host client device 304 is a smart mobile device such as a smart phone or a tablet PC. Each application 522 usually contains one or more sets of programmatic code, which is programmed and configured to perform one or more sets of specific functions when loaded and executed by processor 510. In one embodiment, applications 522 may include a proprietary QR code scanner application 522-S (hereinafter referred to as “Proprietary App 522-S” or simply as “Proprietary App”), which is for retrieving the EMR of a patient based on received image data of a scanned QR code.

A client device 304 usually comprises one or more interface modules 504, each of which enables connection of an external device to the host client device 304 (particularly its processor 510) via one or more of various communication protocols. For example, interface modules 504 may include a USB interface module (which may include a USB or micro USB interface and a USB switching circuit). With one or more interface modules 504, data acquired by one or more external devices can be transmitted to processor 510, and may then be used by one or more applications 522 executed by processor 510 or transferred to another module, such as image processing module 541, for further processing.

Camera module 540 provides camera functions in capturing images by converting optical images into digital image data. Typically, camera module 540 may comprise one or more lenses through which optical images are captured, one or more image sensors which convert captured optical images into analog image signals, and an internal signal processor for converting analog image signals to corresponding digital image data.

Image processing module 541 comprises one or more image encoders and/or decoders for performing encoding and/or decoding functions on received image data. More specifically, image processing module 411 receives digital image data and may encode received digital image data into image data of a format, such as JPEG format. Image processing module 411 may decode received image data of a format, such as JPEG format, into a different format.

In one embodiment, camera module 540 is coupled to image processing module 541, and provides its output digital image data to image processing module 541 for processing (encoding and/or decoding). Image processing module 541 is coupled to display module 530, and outputs image data to display module 530 for display.

In another embodiment, processor 510 may include a switching control module 506. Switching control module 506, after detecting image signals from, e.g. interface modules 504, either supplies the image signals to one or more applications 522 executed by processor 510 or transfers the image signals to audio image processing module 541 for further processing.

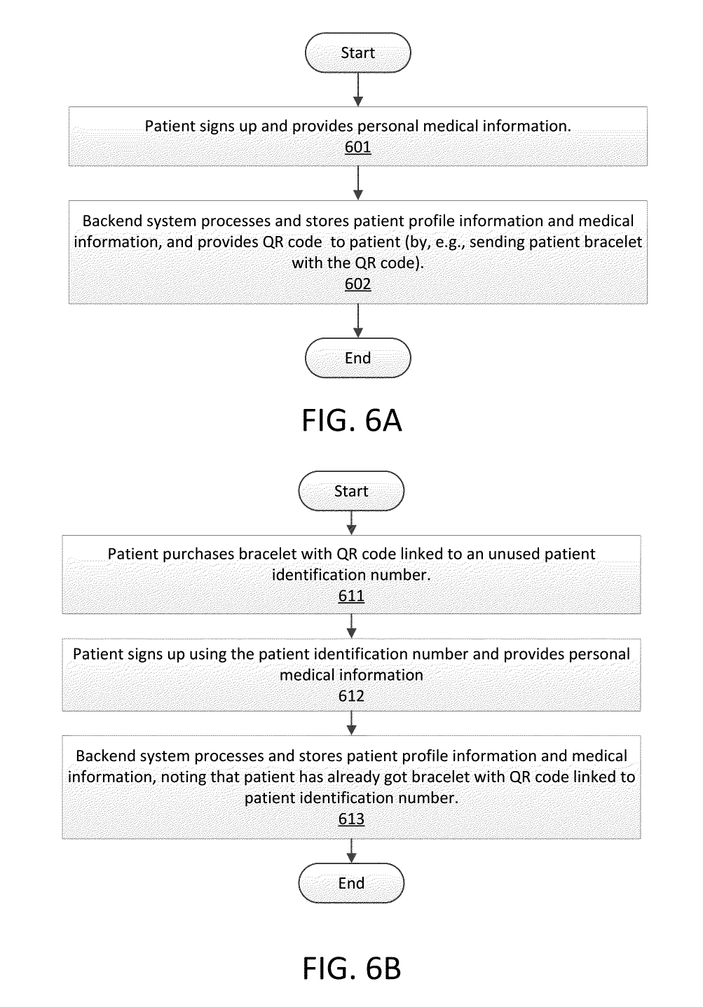

FIGS. 6A-6B are flowcharts illustrating a patient registration process as a part of the presently disclosed system and method of expediting legal access of the EMR of a patient, according to two or more embodiments of the present disclosure. As used herein, the terms “block” and “step” may be used interchangeably to refer to a set of programmatic (software) code or instructions adapted to perform one or more specific functions (when executed by one or more processors), or the one or more performed specific functions, or any combination thereof.

Referring to FIG. 6A, which illustrates one embodiment of a patient registration process, at block 601, a patient signs up with backend system 302 and provides his or her medical information to the backend system 302.

A communication channel is first established between a client device 304 of the patient (such as a tablet PC) and backend system 302. In one embodiment, the communication channel is established between the client device 304 and server 312 of backend system 302 via one or more communication networks (not shown). The patient is then presented in an application 522-A (such as a web browser) one or more forms through which the patient can provide his or her profile information and medical information. In one embodiment, the one or more forms are provided and transmitted to application 522-A by patient registration module 314-C (hereinafter referred to as “PRM 314-C”) of server 312. The one or more forms may be provided using multiple screens or pages. There may be provided in application 522-A related UI screens that allow the patient to review or preview submission of the one or more forms. There may be provided one or more UI buttons in application 522-A which allow the patient to submit, for example, one entire form, portions of one form, or several forms, to backend system 302.

The profile information which the patient is asked to provide is used to identify the patient. Some of the patient's profile information may be also used as the patient's medical information. The profile information may include the patient's name, date of birth, a government-issued identification number (such as a social security number or driver's license number), address, telephone number, e-mail address, physical characteristics (such as height, color of eyes, and etc.). In one embodiment, for security purposes, the patient may also be asked to provide, as part of the profile information, answers to security questions. Optionally, for security purposes, the patient may be asked to upload, as part of the profile information, the patient's biometric information, such as the patient's fingerprint, through hardware and software available to the client device 304.

The medical information that the patient is asked to provide may be classified and organized into two sets, namely, (a) basic medical information and (b) full medical information used as the patient's EMR, with the latter usually inclusive of the former. In particular, basic medical information of the patient may include name, medical problems, basic list of medications and allergies. Full medical information of the patient (which will be used interchangeably with “patient's EMR”) may include, in addition to the basic medical information of the patient, date of birth, address, phone number, social security number, next of kin information, health insurance information.

Further, the patient's EMR (which the patient is asked to provide) may include detailed information about the patient's medical problems, such as the year in which a medical problem is diagnosed, and the doctor who diagnosed a medical problem. Still further, the patient's EMR may include detailed information about the patient's medications, such as the number of times which the patient is taking or took a medication daily, the doctor who prescribed a medication, and the pharmacy at which the patient picked up a medication. Still further, the patient's EMR may include detailed information about the surgeries which the patient may have had, such as the names of the surgeries that the patient has had, the time at which a surgery is performed, the place where a surgery is performed, the allergies which the patient has had after a surgery, the types of reactions that a patient has had to a surgery, and the extent and degree of those reactions. Still further, the patient's EMR may include files related to laboratory reports, radiology report, EKG and etc., as well as files related to legal documents, such as Power of Attorneys (POA), Medical POA, Durable POA, Do Not Resituate Orders, Term Life Insurance, Whole Life Insurance, and etc.

After the patient fills in the one or more forms directed to the patient's profile information and medical information, the patient, by clicking one or more UI buttons available in the application 522 where the one or more forms are presented, submits the patient-provided profile information and medical information to backend system 302 through submission of the one or more forms to backend system 302 via the established communication channel. In one embodiment, the one or more filled-in forms are submitted to server 312 of backend system 302 via a communication channel established between the client device 304 and server 312.

At block 602, backend system 302, upon receiving submitted patient-provided profile information and medical information, processes patient profile information and medical information, and subsequently provides a QR code to the submitting patient. In one embodiment, block 602 is performed by server 312 of backend system 302. More specifically, web server module 314-A, upon receiving the submitted patient-provided profile information and medical information, calls PRM 314-C to process the submitted patient-provided profile information and medical information.

PRM 314-C establishes a new patient profile—or in other words, a new patient account—for the newly registered patient. By way of example and not limitation, PRM 314-C generates a unique patient identification number (hereinafter referred to as “PIDN”) and assigns the generated PIDN to the patient, so that the patient can be uniquely identified by the PIDN. In one embodiment, the PIDN is a string of alphanumeric characters. Optionally, PRM 314-C may generate a temporary or permanent password for the patient to log into backend system 302 based on the PIDN. The patient may be allowed to change the patient's password to secure the patient's access to the patient's account. Also, PRM 314-C stores the received patient-provided profile information (along with the PIDN used to identify the patient) in PPDS 401 of data store 313, so that user profile information for the patient can later be retrieved.

Additionally, PRM 314-C sets up the patient's EMR by storing the received patient-provided medical information, along with the PIDN assigned to the patient, in PMDS 402. PPDS 401 and PMDS 402 may be interconnected with each other via, e.g., the PIDN assigned to the patient. As noted above, the patient's EMR may include some of the patient's profile information. Thus, applicable data may need to be first retrieved from both PPDS 401 and PMDS 402 and then combined before the patient's EMR is formed. Also, profile information and medical information considered as basic medical data of the patient may be indicated in both PPDS 401 and PMDS 402 to facilitate the provision of basic medical data of the patient.

Further, PRM 314-C generates a QR code for the retrieval of the patient's EMR. In one embodiment, PRM 314-C generates an HTTP URL directed to web server module 314-A of server 312. A “pass key”, which is formed of one or more strings of alphanumeric characters, is additionally generated using the PIDN. The pass key is later either appended or embedded into the HTTP URL to form a final HTTP URL directed to web server module 314-A. In one embodiment, the pass key is the patient's PIDN. One example of such a final HTTP URL is: “http://www.triplestat.com/EMR?PIN=[PIDN].” In another embodiment, the pass key a combination of the PIDN and a hash string encoded by an encoding scheme using PIDN and one or more other parameters only known to backend system 302. For example, the hash string may result from binding PIDN and the patient's, e.g., date of birth together using the encoding scheme known as MD5. Thus, in this case, the pass key may be a combination of the PIDN and the encoded hash string. One example of the final HTTP URL so formed is: “http://www.triplestat.com/EMR?HASH=[hash generated using PIDN]&PIN=[PIDN].” The QR code is generated to encode the final HTTP URL.

The generated QR code may be provided to the patient in one or more various forms. For example, the QR code may available for download on the web site of backend system 302 via the patient's profile page, so that the patient can obtain the QR code through downloading. Alternately and/or additionally, the QR code may be sent to the patient via an e-mail so that the patient may obtain the QR code through the e-mail. In either case, the patient is expected to print out the QR code so that the patient may carry the QR code in printed form. As another example, the QR code may be provide to the patient in the form of a bracelet, with the bracelet carrying the QR code in one or more manners exemplified in FIGS. 1A-1D.

FIG. 6B illustrates another embodiment of a patient registration process as a part of the presently disclosed system and method of expediting legal access of the EMR of a patient. At block 611, a patient purchases off a commercial shelf a bracelet carrying a QR code linked to an unused PIDN. Also provided in the packaging of the bracelet are the unused PIDN, the URL of the web site of backend system 302 for patient registration, and a temporary password that the patient needs to sign up with backend system 302 using the unused PIDN.

At block 612, the patient visits the patient registration web site of backend system 302 and signs up with the system using the provided PIDN and the temporary password. At block 613, backend system 302 processes and stores patient profile information and medical information, noting that patient has already got bracelet with QR code linked to PIDN.

Blocks 612 and 613 are similar to blocks 601 and 602, respectively, with a few exceptions. First, with respect to blocks 612 and 613, the patient was provided a QR code and an unused PIDN in advance of the execution of any of these two blocks. This is different from blocks 601 and 602, where the patient is provided (assigned) a unique patent identification number during or after the signing-up as carried out by blocks 601 and 612. Second, during block 613, backend system 302 assigns the previously unused PIDN to the patient, so that the PIDN is no longer unused. In one implementation, backend system 302 maintains a data store (not shown) storing a set of unused PIDNs as well as corresponding temporary passwords. Thus, during block 613, PRM 314-C, upon assigning the previously unused PIDN to the patient, removes the same PIDN and related data (such as the corresponding temporary passwords) from the data store. This step, however, may not be needed in block 602. Third, during block 612, the patient is required to first log in using the pre-provided patent identification number and temporary password. After the initial login, the patient is presented with one or more forms for furnishing profile information and medical information. During block 612, the patient may be prompted to change the temporary password to a permanent password of the patient's own. This is different from block 601, where the patient is not required to perform an initial login using pre-provided patent identification number and temporary password. Instead, the patient is directly presented with one or more forms for furnishing profile information and medical information, and the patient may be directly asked to provide a permanent password for login purposes.

With the two alternative exemplary embodiments illustrated in FIGS. 6A and 6B, a patient is able to sign-up with backend system 302 and store the patient's EMR with backend system 302 via the patient registration process. Additionally, backend system 302 is configured such that after the initial registration, the patient can securely update the patient's profile information and medical information from time to time stored therein via logging into the patient's account established through blocks 601-602 or blocks 612-613.

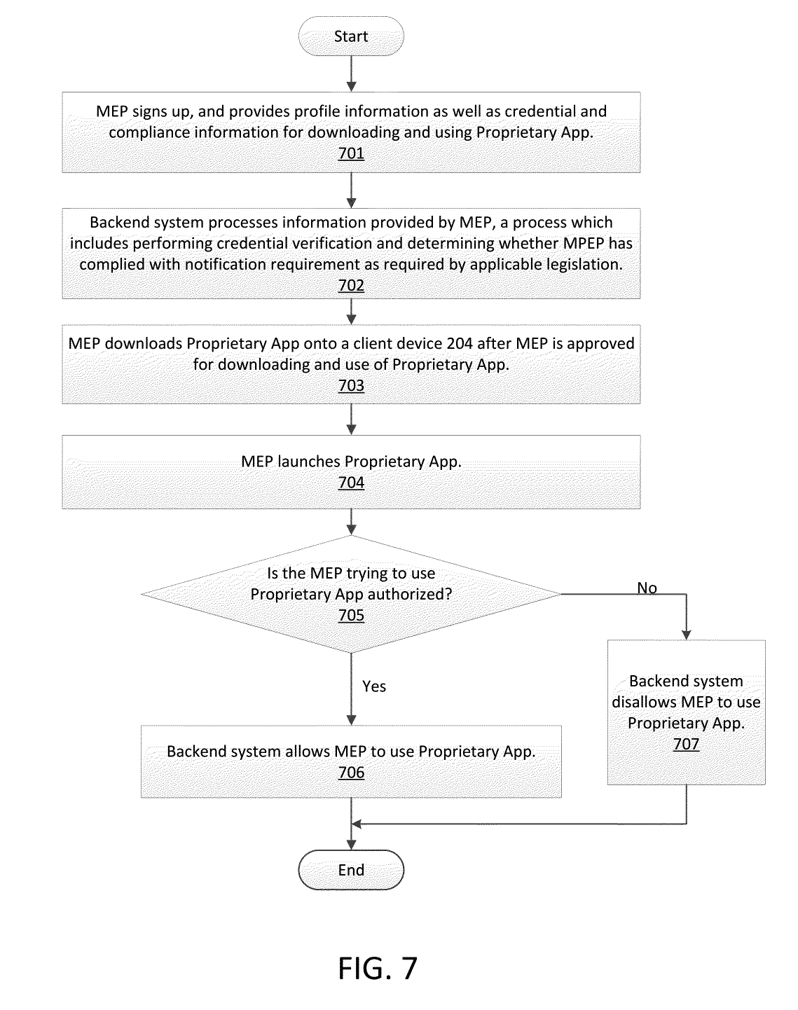

FIG. 7 is a flowchart illustrating a medical emergency professional registration process as a part of the presently disclosed system and method of expediting legal access of the EMR of a patient, according to one or more embodiments of the present disclosure.

At block 701, a medical emergency professional (hereinafter referred to as “MEP”) signs up with backend system 302 for the privilege of downloading and using Proprietary App 522-S. As used herein, the terms “medical emergency professional” and “MEP” refer to any person who is legally allowed to get access of a patient's EMR during an emergency situation in connection with a patient's medical condition. In particular, a “medical emergency professional” or “MEP”, in the context of the present disclosure, does not have to be directly related to a medical field. A “medical emergency professional” or “MEP” can be any of a paramedic, a nurse, a doctor, a police officer, a fire fighter, and etc., who is typically granted a credential, such as a license, by a government, such as the federal, a state or a local government, to perform the line of work associated with the title thereof.

A communication channel is first established between a client device 304 of an MEP (such as a smartphone, a tablet PC, a desktop PC or a laptop PC) and backend system 302. In one embodiment, the communication channel is established between the client device 304 and server 312 of backend system 302 via one or more communication networks (not shown). The MEP is then presented in an application 522-B (such as a web browser) one or more forms through which the MEP can provide his or her profile information, and credential and compliance information. In one embodiment, the one or more forms are provided and transmitted to application 522-B by medical emergency professional registration module 314-D (“MEPRM 314-D”) of server 312. The one or more forms may be provided using multiple screens or pages. There may be provided in application 522-B related UI screens that allow user to review or preview submission of the one or more forms. Additionally, there may be provided in application 522-B one or more UI buttons that allow a user to submit, for example, one entire form, portions of one form, or several forms, to backend system 302.

The profile information may include the MEP's name, date of birth, a government-issued identification number (such as a social security number or driver's license number), home address, telephone number, e-mail address, and etc. In one embodiment, for security purposes, the patient may also be asked to provide, as part of the profile information, answers to security questions. Optionally, for security purposes, the MEP may be asked to upload, as part of the profile information, the MEP's biometric information, such as the MEP's fingerprint, through hardware and software available to the client device 304.

The credential and compliance information (“CC information”) that the MEP is asked to provide may include the MEP's employment information, such as the employer, the employment address, the job title, and etc. The CC information may additionally include information about the MEP's credential, such as licensing information about the MEP, which may include, the license number of a valid license granted in the line of MEP′ work and the expiration date of a valid license of the MEP. The MEP's credential information may be independently verified by the back office (not shown) of backend system 302. The validity of the MEP's credential may be used as a criterion to decide whether the MEP is authorized to download and use Proprietary App 522-C.

The CC information further includes information concerning the MEP's compliance with, e.g., federal or state legislations in connection with handling medical emergencies, such as HIPAA and/or HITECH. For example, the MEP may be asked to respond to, acknowledge the receipt of, and/or sign, applicable forms, such as HIPAA/HITECH forms during block 701. If the applicable forms, as required by the relevant legislations in connection with handling medical emergencies, are properly responded to, acknowledged the receipt thereof, and/or signed, as required by the legislations, then backend system 302 or the operator/ownership thereof, can, for example, legally have access to the MEP's phone number and track the MEP with accuracy. This results in that the MEP is legally no longer subject to one or more legislatively required steps (during a process of accessing the EMR of a patient) which otherwise would be subject to (during the same process). Putting it differently, with the MEP's proper responses to, acknowledgements of the receipt of, and/or signings of, one or more applicable forms required by the legislations, the MEP can legally skip responding to, acknowledging the receipt of, and/or signing, the one or more applicable forms during a process of accessing the EMR of a patient using the presently disclosed system and method, thus greatly expediting the legal access of the EMR of a patient by the MEP.

After the MEP fills in the one or more forms directed to the MEP's profile information and CC information, the MEP, by clicking one or more UI buttons available in application 522-B where the one or more forms are presented, submits the MEP-provided profile information and CC information to backend system 302 through submission of the one or more forms to backend system 302 via the established communication channel. In one embodiment, the one or more filled-in forms are submitted to server 312 of backend system 302 via a communication channel established between the client device 304 and server 312.

At block 702, backend system 302, after receiving the submitted MEP-provided profile information and CC information, processes the submitted information, a process which may include verifying the credential information provided by the MEP and determining whether the MEP has complied with the notification requirements set forth in applicable legislations by properly responding to, acknowledging the receipt of, and/or signing, applicable forms, such as HIPAA/HITECH forms. In one embodiment, block 702 is performed by server 312 of backend system 302. More specifically, web server module 314-A, upon receiving the submitted profile information and CC information, calls MEPRM 314-D to process the submitted information.

MEPRM 314-D establishes a new MEP profile—or in other words, a new patient account—for the newly registered MEP. By way of example and not limitation, MEPRM 314-D generates a unique MEP identification number and assigns the generated MEP identification number to the MEP, so that the MEP can be identified by the MEP identification number. In one embodiment, the MEP identification number is a string of alphanumeric characters. Optionally, MEPRM 314-D may generate a temporary or permanent password for the MEP to log into the MEP's newly established account. The MEP may be allowed to change the MEP's password to secure the MEP's access to the MEP's account. Also, MEPRM 314-D stores the received MEP-provided profile information and CC information (along with the MEP identification number) in MEPRDS 403 of data store 313, so that the MEP's profile information and CC information can later be retrieved.

Additionally, MEPRM 314-D may send a notice to, for example, back office personnel, notifying them to verify the validity of the credential information of the MEP. In one embodiment, once the result of the validity the MEP's credential information is obtained by the back office, MEPRM 314-D is invoked to update a field of the MEP′ account indicating that whether the MEP's credential information is valid. Thus, if the MEP′ credential information is verified to be valid, MEPRM 314-D may send the MEP an e-mail or a message notifying the MEP that the MEP is authorized to download and use the Propriety App. If the MEP's credential information is verified to be invalid or expired, MEPRM 314-D may send a different e-mail or message indicating that the MEP is not yet authorized to download and use Propriety App 522-S, and that the MEP is required to resubmit new credential information in order for the MEP to be authorized to download and use Propriety App 522-S.

Further, MEPRM 314-D determines whether the MEP has complied with the notification requirements set forth in applicable legislations by properly responding to, acknowledging the receipt of, and/or signing, applicable forms, such as HIPAA/HITECH forms. In one embodiment, MEPRM 314-D, after performing the determination process, updates a field indicating whether the MEP is compliant based on the determination result. If the MEP is found to be non-compliant, MEPRM 314-D may send the MEP an e-mail or a message notifying the MEP of the non-compliance. Otherwise, the MEP, as noted, the MEP can legally skip responding to, acknowledging the receipt of, and/or signing, one or more applicable forms during a process of accessing the EMR of a patient using, for example, Propriety App 522-S.

At block 703, the MEP downloads Proprietary App 522-S onto a client device 304 after MEP is approved to download and use Proprietary App 522-S. In one embodiment, as the MEP is attempting to download Proprietary App 522-S (e.g., via a special download manager application 522-C), download and use control module 314-E (hereinafter referred to as “DUCM 314-E”) of server 312 is invoked to verify whether the MEP is indeed authorized to download and use Proprietary App 522-S.

In one implementation, the MEP is prompted to provide MEP identification number and password, so that DUCM 314-E can verify against the MEP's stored profile information and CC information to verify whether the MEP identification number and password are valid and whether the MEP is authorized to download Proprietary App 522-S.

In another implementation, the MEP is additionally or alternately prompted to provide biometric information to DUCM 314-E for performing the verifications. If the MEP is verified as authorized, the MEP may then complete the downloading of Proprietary App 522-S.

In yet another implementation, additionally or alternately, during or after the downloading, a special download manager application 522-C may, for security purposes, provide the MAC address of the client device 304 (onto which Proprietary App 522-S is downloaded) to DUCM 314-E so that DUCM 314-E can store the MAC address of the client device 304 in the MEP's profile information for later verification of whether the downloaded Proprietary App 522-S is indeed launched in the very client device 304, so as to ensure the no unauthorized person can have possession of Proprietary App 522-S by illegally copying a downloaded Proprietary App 522-S from one client device 304 to another client device 304 without going through the required downloading process.

At block 704, the MEP launches the downloaded Proprietary App 522-S on the client device 304.

At decision 605, Proprietary App 522-S, as an initial verification step, checks whether the MEP trying to use Proprietary App 522 is authorized. In one implementation, Proprietary App 522-S prompts the MEP to provide MEP identification number and password, and sends commands to server 312 via a communication channel established between the client device 304 and server 312. Upon receiving the commands, DUCM 314-E is invoked to verify against the MEP's information stored in MEPRDS 403 of data store 313 as to whether the MEP is authorized to use the downloaded Proprietary App 522-S. In one scenario, the MEP's license may have been just expired. Thus, although the MEP was authorized to download Proprietary App 522-S previously, the MEP is not authorized to use the downloaded Proprietary App 522-S.

In another implementation, the MEP is additionally or alternately prompted to provide biometric information to DUCM 314-E for verifying whether the person launches the downloaded Proprietary App 522-S is indeed the MEP himself or herself.

In yet another implementation, Proprietary App 522-S, additionally or alternately, obtains the MAC address of the client device 304 and provides the obtained MAC to DUCM 314-E so that DUCM 314-E can check against the previously stored MAC address of the client device 304 used to download Proprietary App 522-S, and verify whether Proprietary App 522-S is launched on the same client device 304 onto which Proprietary App 522-S was previously downloaded.

If the MEP is verified to be authorized to use Proprietary App 522-S, at block 706, DUCM 314-E of backend system 302 sends one or more commands to Proprietary App 522-S, authorizing the MEP to use Proprietary App 522-S. Thus, Proprietary App 522-S proceeds to run on the client device 304 for retrieving the EMR of a patient.

If the MEP is found to be unauthorized to use Proprietary App 522, at block 707, DUCM 314-E of backend system 302 sends one or more commands to Proprietary App 522-S, disallowing Proprietary App 522-S to proceed to run on the client device 304.

To summarize, the blocks and decisions illustrated in FIG. 7 ensures that only authorized MEPs can download and use Proprietary App 522-S, thus eliminating or greatly reducing the possibility of a hacker using Proprietary App 522-S to get hold of the EMR of a patient.

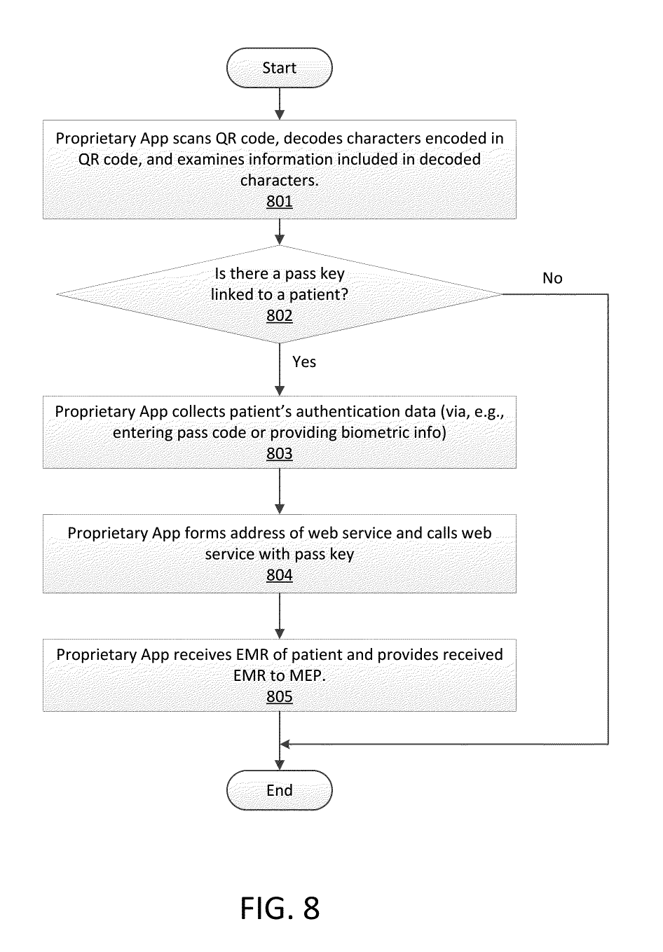

FIG. 8 is a flowchart illustrating how Proprietary App 522-S gets legal access of the EMR of a patient carrying a QR code (issued by backend system 302) in an expedient and secure manner. At block 801, Proprietary App 522-S scans QR code, decodes characters encoded in QR code, and examines information included in the decoded characters.

Specifically, Proprietary App 522-S causes the QR code to be scanned using one or more known technologies. In one implementation, the image of the QR code is captured by camera module 540 and optionally processed by image processing module 541. In another implementation, the image of the QR code may be captured by an external imaging device connected to the host client device 304 through one or more interface modules 504 and transferred to processor 510. The captured image data is then detected and transferred to image processing module 541 (for image processing) by switching control module 506 of processor 510.

Next, Proprietary App 522-S causes the processed image of the QR code (outputted, e.g., from camera module 540 or image processing module 541) to be analyzed and decoded into a string of characters which were originally encoded to form the QR code. The decoding may be realized using one or more known image recognition techniques.

Afterwards, Proprietary App 522-S receives the decoded string of characters and examines information included therein.

At decision 702, Proprietary App 522-S checks whether there is a “pass key” linked to a patient. As noted, a pass key can be a combination of one or more strings of alphanumerical characters. In one implementation, the decoded characters form an HTTP URL. One example of such an HTTP URL is: “http://www.triplestat.com/EMR?PIN=[PIDN].” Thus, in this case, the pass key is just PIDN. Another example of such an HTTP URL is: “http://www.triplestat.com/EMR?HASH=[hash string generated using PIDN]&PIN=[PIDN].” Thus, in this case, the passkey is a combination of PIDN and the hash string included in the HTTP URL. Proprietary App 522-S looks for one or more specific delimiting characters and/or symbols that indicate the presence of a pass key. So for the above-listed two URL examples, Proprietary App 522-S first looks for a string “EMR?.” If the string “EMR?” is located, then Proprietary App 522-S searches “PIN=” or “&PIN=” to locate the PIDN, and/or searches “HASH=” or “&HASH=” to the hash string. If Proprietary App 522-S is able to locate a PIDN and/or a hash string, Proprietary App 522-S decides that a pass key is found. Otherwise, Proprietary App 522-S decides that a pass key is not found.

If the pass key is not found, which indicates that the information encodes in the QR code cannot be used for getting access of the EMR of the patient, Proprietary App 522-S may indicate such to the MEP via a UI display screen, and then proceed to end its operation. If the pass key is deemed found, Proprietary App 522-S proceeds further.

Optionally, at block 803, to ensure security, Proprietary App 522-S, before displaying the EMR of the patient on display module 530, may ask the MEP or the patient to provide additional security information regarding the patient. For example, if the patient is still conscious, Proprietary App 522-S may ask the patient to enter a pass code to authenticate himself or herself to backend system 302. One example of such a pass code is the answer to a security question, such as what the patient's mother's maiden name is. Additionally or alternately, Proprietary App 522-S may have the patient (through the MEP if the patient cannot move) provide the patient's biometric information (through, for example, camera module 540) to backend system 302 for authentication purposes. Thus, through block 803, Proprietary App 522-S collects from the patient authentication data (such as the aforementioned pass code and/or biometric data) for authenticating the patient to backend system 302 before the EMR of the patient is provided to the MEP. As a skilled artisan readily appreciates, the optional authentication is for preventing the retrieving and accessing of the EMR of a patient who is not the patient carrying the QR code in a situation where the patient under emergency situation is somehow carrying somebody else's QR code.

At block 804, Proprietary App 522-S forms an address of a web service of backend system 302 and sends a request for the patient's EMR to the web service by making a web service call to the formed web service address with one or more parameters specifying a request for the patient's EMR. In one implementation, the one or more parameters of the web service call include the patient's PIDN extracted from the decoded HTTP URL. In another implementation, the parameters of the web service call include the patient's PIDN and a hash string (previously generated using the patient's PIDN) extracted from the decoded HTTP URL. In yet another implementation, the parameters of the web service call include, in addition to the pass key information collected from decision 702, the authentication data (such as a personal pass code and/or biometric data of the patient) collected from block 803.

Specifically, a generic scanner application 522-G (not shown), upon receiving the HTTP URL decoded from the captured image of the QR code, sends a web page request to the HTTP URL, which, in one embodiment, corresponds to web server module 314-A of server 312. In response, web server module 314-A, upon extracting the PIDN from the HTTP URL, retrieves from PPDS 401 and PMDS 402 of data store 313 only information indicated or classified as part of the basic medical record of the patient, and sends the retrieved basic medical information to the generic scanner application 522-G. Thus, a generic scanner application 522-G may only receive the basic medical record of the patient upon scanning the QR code carried by the patient.

By contrast, at block 804, Proprietary App 522-S, upon receiving the HTTP URL decoded from the captured image of the QR code, forms an address of a web service using information contained in the HTTP URL (including the pass key linked to the patient), and sends a request for the patient's EMR to backend system 302 by making a corresponding web service call to the formed web service address. If there is no authentication issue with respect to the patient, the web service call results in Proprietary App 522-S receiving the EMR of the patient, rather than only the basic medical information of the patient as received by a generic scanner application 522-G.

At block 805, Proprietary App 522-S receives the EMR of the patient from backend system 302 and provides the received EMR to the MEP (launching Proprietary App 522-S). Pertinent to block 805, conventionally, an application accessing and displaying the EMR of a patient to an MEP is required to display one or more compliance notices and/or forms required by pertinent legislations for the MEP to respond thereto, acknowledge receipt thereof, and/or sign. As noted, these legislative requirements to respond to, acknowledge receipt of, and/or sign, compliance notices and/or forms (requirements which the MPE is subject to), result in considerable inconvenience and delay for the MEP to legally access the EMR of the patient.

By contrast, as noted, with the system-required MEP registration process illustrated in blocks 701 and 702 of FIG. 7, the MEP (using Proprietary App 522-S) can legally skip those potentially burdensome steps (of responding to, acknowledging receipt of, and/or signing, compliance notices and/or forms) as resulted from the legislative requirements. Thus, before or during block 805, Proprietary App 522-S does not display those compliance notices or forms which otherwise are required to be displayed for the MEP to respond thereto, acknowledge receipt thereof, and/or sign. Instead, Proprietary App 522-S, upon receipt of the EMR of the patient, provides the received EMR to the MEP without any pause or delay—by, e.g., displaying the received EMR on display module 530 in one or more viewable forms and/or sending the received EMR to a known e-mail address of the MEP in one or more readable forms—thereby expediting the MEP's legal access of the EMR of the patient.

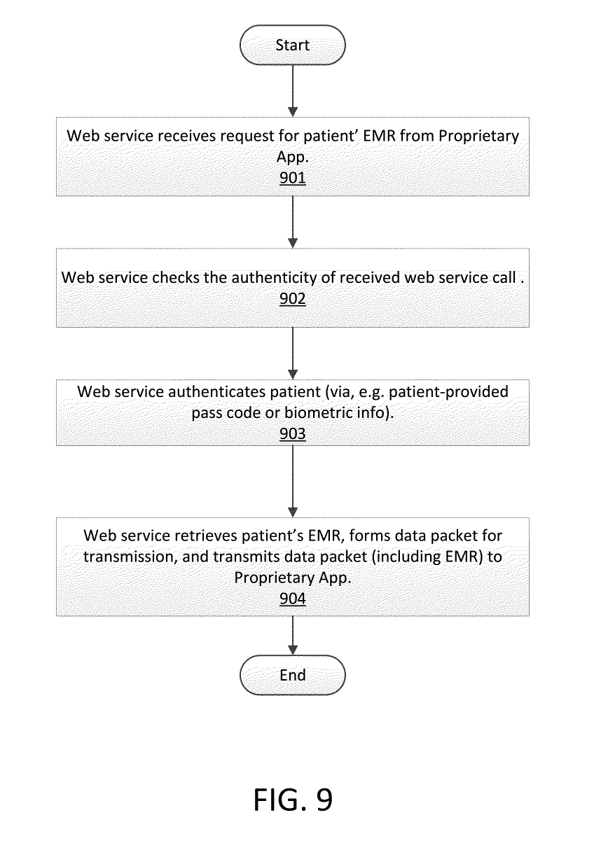

FIG. 9 is a flowchart illustrating how web service module 314-B responds to a request sent by Proprietary App 522-S for providing the EMR of a patient. At block 901, web service module 314-B (hereinafter referred to as “WBM 314-B”), upon being invoked resulting from the web service call made by Proprietary App 522-S, receives the request sent by Proprietary App 522-S for providing the EMR of a patient identified by the PIDN included as one of the one or more parameters of the web service call.

Optionally, at block 902, WBM 314-B checks the authenticity of the received web service call. In one implementation, the parameters of the web service call includes both a PIDN (identifying a patient) and a hash string previously generated using the PIDN as well as authentication data of the patient (such as the date of birth of the patient) collected from the patient during block 803. During block 902, WBM 314-B regenerates a hash string using the PIDN. Then, WBM 314-B compares the received hash string to the regenerated hash string, checking whether the two hash strings match. If it is a match, the received web service call is deemed authentic. Thus, WBM 314-B further proceeds. Otherwise, the received web service call is deemed not authentic, suggesting or indicating that the received web service call may result from a malicious hacking attack. Thus, WBM 314-B proceeds to end its handling of the received web service call.

Optionally, at block 903, WBM 314-B authenticates patient by verifying the authentication data included in the parameters of the web service call. In one implementation, WBM 314-B verifies the pass code (such as the patient-provided answer to a security question) included in the parameters against the pass code stored in PPDS 401. Additionally or alternately, WBM 314-B verifies the biometric data (as collected from the patient by the MEP launching the requesting Proprietary App 522-S) included in the parameters against the biometric data stored in PPDS 401. If one or more verification results collectively and confidently suggest to WBM 314-B that the patient carrying the QR code is indeed the patient to whom the QR code was issued by backend system 302, WBM 314-B proceeds further.

At block 904, WBM 314-B retrieves the patient's EMR, forms one or more data packets, and sends the formed one or more data packets to the requesting Proprietary App 522-S. In one embodiment, WBM 314-B retrieves the patient's EMR using the patient's PIDN included in the parameters of the web service call. After the retrieval of the patient's EMR, WBM 314-B forms one or more data packets (inclusive of data of the patient's EMR) suitable for secure transmission. In one implementation, WBM 314-B forms a plurality data packets and transmits one data packet at a time to the requesting Proprietary App 522-S, with data packets subsequent to the very first data packet being transmitted on demand.

In this implementation, the first data packet may include part of the EMR that are expressed or provided in the form of text. Data packets subsequent to the very first data packet may be part of the EMR that are provided in the form of files (previously uploaded to backend system 302). In another implementation, additionally or alternately, each data packet is encoded to ensure security of the transmission thereof. For example, each data packet is encoded such that the receiving Proprietary App 522-S can decode the data packet via a channel using a secure communication protocol, such as SSL.

As noted above, upon receiving the patient's EMR, Proprietary App 522-S is able to provide access of the patient's EMR to the MEP (launching the Proprietary App 522-S) handling an emergency situation in connection with the patient carrying the QR code.

With the embodiments described above in reference to the illustrated figures, the presently disclosed system and method can effectively expedite the legal access of a patient's EMR utilizing QR codes and a proprietary scanner application.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

What is claimed is:

1. A system of providing expedited legal access of EMR record of a patient, the system comprising:
means for receiving EMR data of a patient;
propriety application means for retrieving EMR data of a patient, comprising scanning means and data-retrieving means, the scanning means configured to scan QR-code of the patient, the EMR-data-retrieving means configured to retrieve full EMR data of the patient from a non-http-addressed server whose address is derived from http-address encoded in the scanned QR-code; and
means for verifying credential of a medical emergency professional (MEP) so as to enable the MEP to use the propriety application means.
